(19) United States
(12) Patent Application Publication
(10) Pub. No.: US 2025/0182288 A1
(43) Pub. Date: Jun. 5, 2025

(54) SPIKE NUMBER PREDICTION DEVICE

(71) Applicant: NTT DOCOMO, INC., Tokyo (JP)

(72) Inventors: Ryosuke MIZUNO, Chiyoda-ku (JP); Takuya KITADE, Chiyoda-ku (JP)

(73) Assignee: NTT DOCOMO, INC., Tokyo (JP)

(21) Appl. No.: 18/845,103

(22) PCT Filed: Feb. 7, 2023
(86) PCT No.: PCT/JP2023/004008

§ 371 Date: Sep. 9, 2024

(30) Foreign Application Priority Data
Mar. 15, 2022 (JP) 2022-039959

(51) Int. Cl. G06T 7/11

(52) U.S. Cl. CPC G06T 7/11; G06T 2207/20076; G06T 2207/30188; G06T 2207/30242

(57) ABSTRACT

A spike number prediction device (10) includes: a spike number counting unit (14A) and the like configured to count, from image data obtained by imaging a two-dimensional unit region (frame F) provided in a wheat cultivation field (30), the number of wheat spikes from the frame F based on an image recognition technique; a correction unit (14B) configured to correct a spike number count value obtained by counting based on correlation information between a spike number count value obtained in advance by statistical processing and a spike number true value; and a spike number prediction unit (14C) configured to predict, based on a relative size relationship between a predetermined target range in the wheat cultivation field and the frame F, and a corrected spike number value after correction, the number of wheat spikes in the target range.

### TECHNICAL FIELD

The present disclosure relates to a spike number prediction device that predicts the number of spikes of grain. The term “grain” means agricultural crops whose seeds are generally consumed by humans, and examples of the grain include wheat, rice, millet, and barley. The term “spike of grain” means a cluster of flowers or fruits at the end of a stalk of grain, and in counting the number of spikes of grain, a cluster of flowers or fruits at the end of a stalk of grain is counted as one.

### BACKGROUND ART

In wheat cultivation, topdressing to provide necessary nutrients according to the growth of wheat is essential, and, it is necessary to ascertain the number of wheat spikes to appropriately determine an amount of topdressing. Incidentally, a significant amount of effort is required for actually counting the number of wheat spikes manually. For this reason, it is conceivable to use an image recognition technique based on artificial intelligence (AI) to allow recognition of wheat spikes from image data in which a wheat cultivation field is reflected and prediction of the number of wheat spikes. Such circumstances also exist in predicting the number of spikes of grain other than the number of wheat spikes.

### CITATION LIST

### Patent Literature

[Patent Literature 1] Japanese Unexamined Patent Publication No. 2020-087286

### SUMMARY OF INVENTION

### Technical Problem

Patent Literature 1 describes an example where counting processing for the number of small objects (for example, stalks of agricultural crops) is executed using an image recognition technique based on artificial intelligence. However, in predicting the number of small objects from a count value obtained by the counting processing as described above with satisfactory accuracy, it is desirable to perform prediction by compensating for information unreadable or illegible from an image such as the number of small objects hidden behind leaves of agricultural crops and the degree of denseness of agricultural crops; however, such circumstances have not been considered in Patent Literature 1, and there is room for improvement in improving prediction accuracy.

The present disclosure has been accomplished to solve the above-described problem, and an object of the present disclosure is to predict the number of spikes with more satisfactory accuracy by compensating for information unreadable or illegible from an image in spike number prediction processing.

### Solution to Problem

There is provided a spike number prediction device according to the present disclosure that predicts the number of spikes of grain, the spike number prediction device including a spike number counting unit configured to count, from image data of the grain obtained by imaging a two-dimensional unit region set in a cultivation field of the grain, the number of spikes of the grain of the two-dimensional unit region based on an image recognition technique, a correction unit configured to correct a spike number count value obtained by counting in the spike number counting unit based on correlation information between a spike number count value obtained in advance by statistical processing and a spike number true value, and a spike number prediction unit configured to predict, based on a relative size relationship between a predetermined target range in the cultivation field of the grain and the two-dimensional unit region, and the corrected spike number value after correction by the correction unit, the number of spikes of the grain in the target range.

In the above-described spike number prediction device, the spike number counting unit counts the number of spikes of the grain of the two-dimensional unit region from the image data of the grain obtained by imaging the two-dimensional unit region based on the image recognition technique, and the correction unit corrects the spike number count value obtained by counting based on the correlation information between the spike number count value obtained in advance by statistical processing and the spike number true value. As an example, the correction unit may correct the spike number count value by applying the spike number count value obtained by counting to “a relational expression between the spike number count value and the spike number true value” generated in advance from a graph where multiple combinations of the spike number true value obtained by counting in the cultivation field of the grain and the number of detected spikes (spike number count value) obtained by detecting and counting the spikes of the grain from the image data of the same cultivation field are plotted. Thereafter, the spike number prediction unit predicts the number of spikes of the grain in the target range based on the relative size relationship between the target range and the two-dimensional unit region, and the corrected spike number value after correction. As above, after the spike number count value is corrected, the number of spikes of the grain is predicted. Thus, it is possible to predict the number of spikes with more satisfactory accuracy by compensating for information unreadable or illegible from an image such as spikes of grain hidden behind leaves and densely distributed spikes of grain.

### Advantageous Effects of Invention

According to the present disclosure, it is possible to predict the number of spikes with more satisfactory accuracy by compensating for information unreadable or illegible from an image.

### BRIEF DESCRIPTION OF DRAWINGS

FIG. 1 is a functional block configuration diagram of a spike number prediction device and related equipment in an embodiment of the invention.

FIG. 2 is a flowchart illustrating processing pertaining to spike number prediction.

FIG. 3 is a diagram illustrating processing until wheat spike detection.

FIG. 4(a) is a diagram illustrating a case where a rectangular region in which directions of respective sides are predetermined and are specified from coordinates of both ends of a diagonal line, set in a wheat cultivation field is used as a two-dimensional unit region, and FIG. 4(b) is a diagram illustrating a case where a region specified by arranging a plurality of rectangles having known longitudinal and lateral lengths along a predetermined biaxial direction with one-point coordinates set in a cultivation field of grain as a reference is used as a two-dimensional unit region.

FIG. 5 is a diagram illustrating an example where a correction expression representing a degree of discrepancy between a wheat spike number true value (real number) obtained by counting in a wheat cultivation field and the number of detected spikes (spike number count value) obtained by counting from image data of the corresponding wheat cultivation field is generated and is applied to a detection result of artificial intelligence.

FIG. 6 is a diagram illustrating a correlation relationship between the wheat spike number true value (real number) obtained by counting in the wheat cultivation field and a ridge width of the corresponding wheat cultivation field.

FIG. 7 is a diagram illustrating a hardware configuration example of the spike number prediction device.

### DESCRIPTION OF EMBODIMENTS

Hereinafter, an embodiment of a spike number prediction device according to the present disclosure will be described with reference to the drawings.

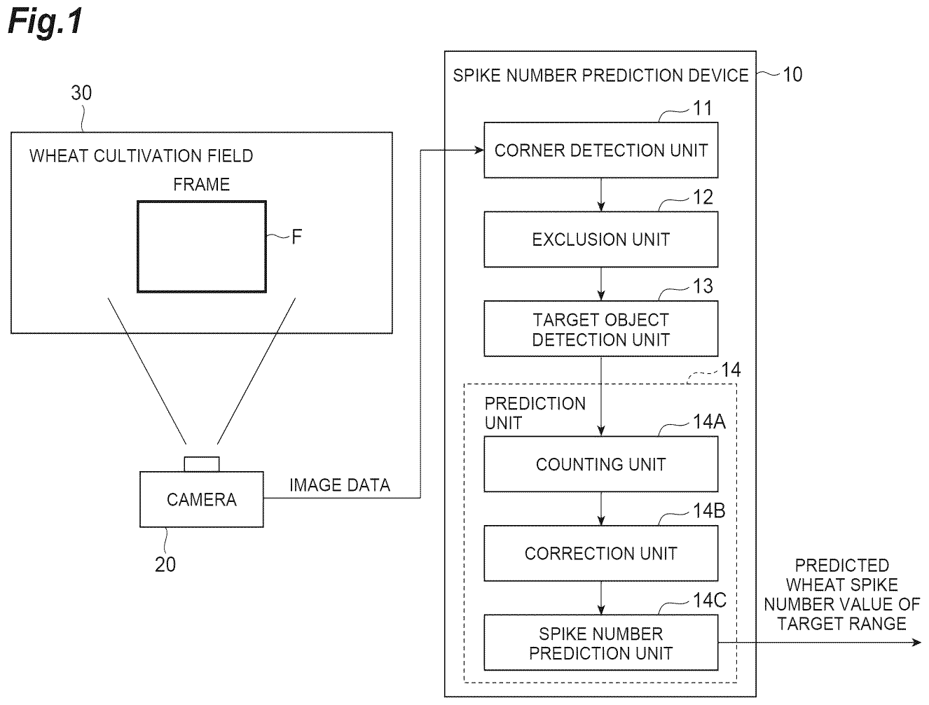

A spike number prediction device 10 according to the embodiment illustrated in FIG. 1 acquires image data of a region image in which a region including a rectangular frame F provided in a wheat cultivation field 30 is reflected as an example of a two-dimensional unit region set in a cultivation field of grain with a camera 20 and predicts the number of spikes (here, the number of wheat spikes) of grain in a target range (for example, the entire wheat cultivation field 30) from the image data.

The spike number prediction device 10 includes, as functional blocks for implementing functions pertaining to the present disclosure, a corner detection unit 11, an exclusion unit 12, a target object detection unit 13, and a prediction unit 14. Hereinafter, the functions of the respective units will be described.

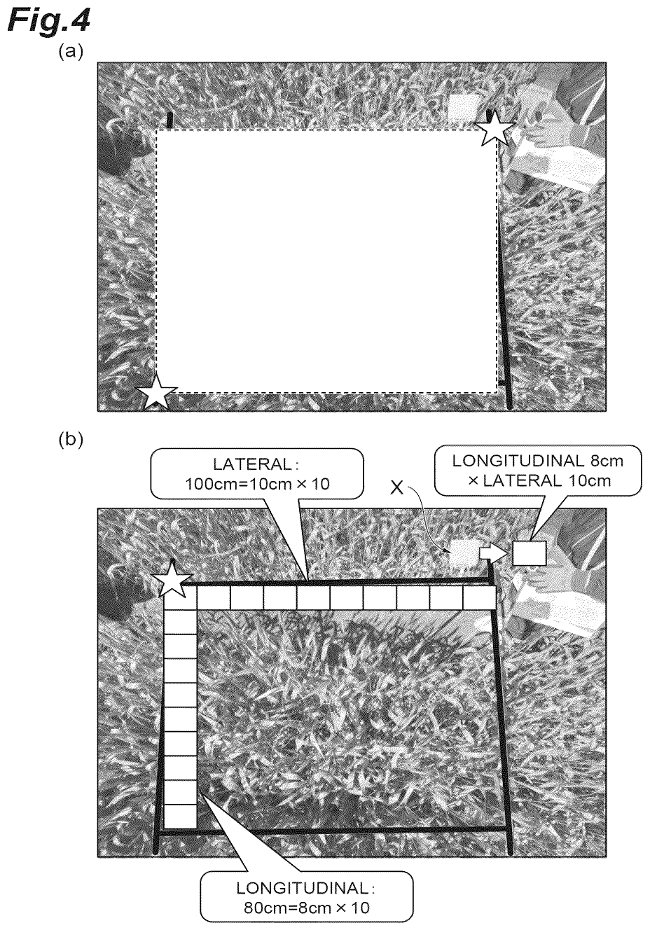

The corner detection unit 11 is a functional unit that acquires image data of a region image in which a region including a rectangular frame F provided in the wheat cultivation field 30 is reflected with the camera 20, divides the region image into grids by image processing on the acquired image data, and detects corners of the frame F in obtained first divided images using an existing image recognition technique. With the detection of the corners of the frame F herein, positional coordinate information of four corners of the frame F in a two-dimensional coordinate system set in image data of the region image is obtained. In the present embodiment, while an example where the real rectangular frame F, not a virtual frame, is used as the two-dimensional unit region set in the cultivation field is described, other variations will be described below with reference to FIGS. 4(a) and 4(b).

The exclusion unit 12 is a functional unit that acquires a position of the frame F in the wheat cultivation field 30 from the positions (that is, position coordinates of the four corners of the frame F in the two-dimensional coordinate system set in the image data of the region image) of the corners detected by the corner detection unit 11 and excludes image data of a region outside the frame F from the image data of the first divided images.

The target object detection unit 13 is a functional unit that performs grid division on an image based on image data after exclusion by the exclusion unit 12 in a division size according to a size of a target object (wheat spike) and detects the target objects (wheat spikes) from obtained second divided images. “Grid division in the division size according to the size of the target object (wheat spike)” herein is grid division to obtain the “second divided images” in which a proportion of pixels occupied by the target object is appropriately increased while avoiding a situation in which features of the target object become unclear or disappear, and for example, grid division in the division size according to the size of the target object (spike of grain) obtained empirically or by an experiment in advance in which the target objects can be detected such that the features of the target object are not unclear and do not disappear. That is, an image based on image data after exclusion in the exclusion unit 12 becomes an entire image, the entire image is subjected to grid division again, the “second divided images” in which the target objects can be detected such that the features of the target object are not unclear and do not disappear and the proportion of the pixels occupied by the target object is appropriately increased are obtained, and the target object detection unit 13 detects the target objects (wheat spikes) from such second divided images.

The prediction unit 14 is a functional unit that counts the number of target objects (wheat spikes) detected by the target object detection unit 13 and predicts, from a relative size relationship between a predetermined target range (here, for example, the entire wheat cultivation field 30) in a cultivation field of grain and the frame F, and a spike number count value obtained by counting, the number of wheat spikes in the target range. The prediction unit 14 includes a counting unit 14A, a correction unit 14B, and a spike number prediction unit 14C. Of these, the counting unit 14A is a functional unit that counts the number of spikes of wheat spikes detected by the target object detection unit 13, and the correction unit 14B is a functional unit that corrects a spike number count value obtained by counting in the counting unit 14A using a method described below to improve the accuracy of wheat spike number prediction. The spike number prediction unit 14C is a functional unit that predicts, based on a relative size relationship between a predetermined target range (for example, the entire wheat cultivation field 30) and the frame F, and a corrected spike number value after correction in the correction unit 14B, the number of wheat spikes in the target range. A “spike number counting unit” in the claims corresponds to the corner detection unit 11, the exclusion unit 12, the target object detection unit 13, and the counting unit 14A in FIG. 1.

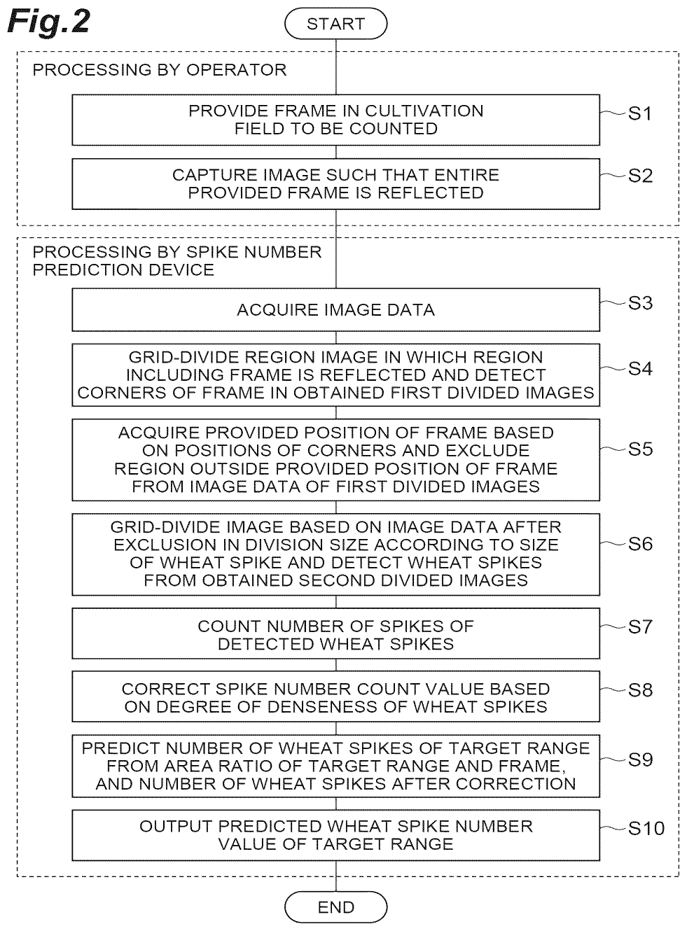

Next, processing pertaining spike number prediction will be described along a flowchart of FIG. 2. As illustrated in FIG. 2, the processing includes processing by the spike number prediction device 10 (Steps S3 to S10) and processing by an operator (Steps S1 and S2) corresponding to preliminary preparation.

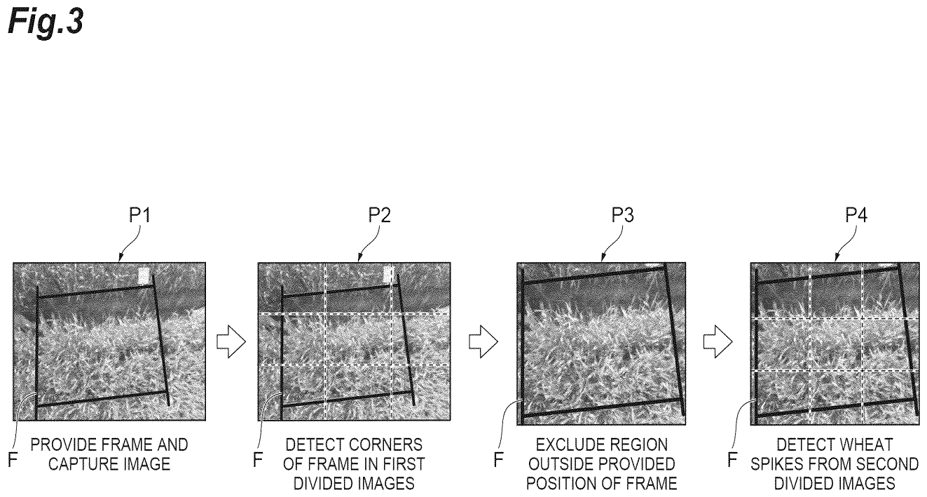

First, as the processing by the operator, the operator provides a frame F in a cultivation field to be counted (Step S1), and captures an image with the camera 20 such that the entire provided frame is reflected (Step S2). With this, image data of a region image in which a region including the frame F is reflected, as illustrated in an image example P1 of FIG. 3 is obtained.

Next, as the processing by the spike number prediction device 10, the corner detection unit 11 acquires image data of the region image in which the region including the frame F is reflected (Step S3), divides the region image into, for example, 3×3 grids as illustrated in an image example P2 of FIG. 3, and detects corners of the frame F in obtained first divided images based on an existing image recognition technique (Step S4).

Then, the exclusion unit 12 acquires a position of the frame F based on positions (position coordinate data) of the detected corners and excludes a region outside of the frame F from image data of the first divided images based on the acquired position of the frame F (Step S5). An image example after outside region exclusion is illustrated in an image example P3 of FIG. 3. Actually, in a case where the frame F is reflected with slightly distorted from a rectangular shape, while the entire outside region is unable to be completely excluded, exclusion processing of Step S5 is executed such that at least the entire region of the frame F remains.

Next, the target object detection unit 13 divides an image based on image data after exclusion in the exclusion unit 12 into, for example, 3×3 grids as illustrated in an image example P4 of FIG. 3 and detects target objects (wheat spikes) from obtained second divided images based on an existing image recognition technique (Step S6). In “grid division” herein, for example, grid division is performed in a division size according to the size of the target object (spike of grain) obtained in advance empirically or by an experiment in advance in which the target objects can be detected such that the features of the target object are not unclear and do not disappear, and the “second divided images” in which a proportion of pixels occupied by the target object is appropriately increased are obtained.

In Steps S4 and S6 described above, division does not need to be made into 3×3 grids, and division may be made into N×M (N and M are any natural numbers) grids. In Steps S4 and S6, division does not need to be made into the same N×M (N and M are any natural numbers) grids, and division may be made into grids different from each other.

Next, the counting unit 14A counts the number of spikes of wheat spikes detected by the target object detection unit 13 (Step S7), and the correction unit 14B corrects a spike number count value obtained by counting in the counting unit 14A using the following method (Step S8).

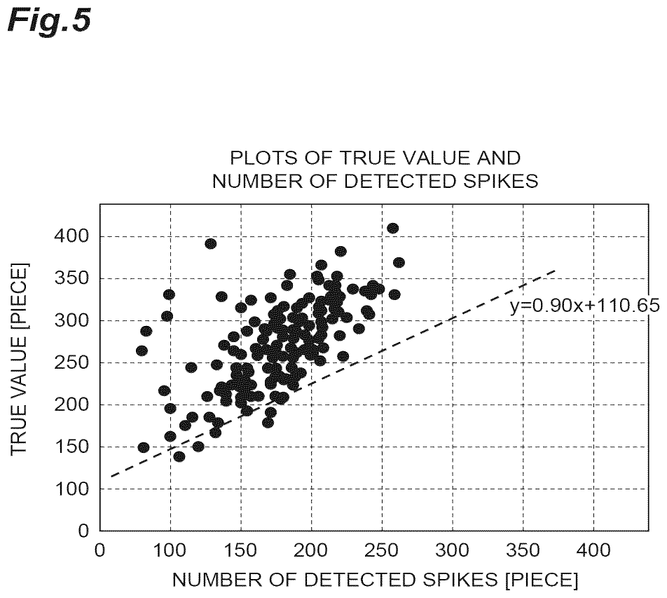

For example, the correction unit 14B obtains a spike number count value after correction to be expected to approach a true value (real number) by obtaining a correction expression (true value=A2×number of detected spikes+M) of a single regression model for correcting the number of detected spikes (the spike number count value obtained by counting in the counting unit 14A) to approach a true value (real number) in advance by a statistical processing and in Step S8, applying the spike number count value to the correction expression of the single regression model obtained in advance. The correction expression (true value=A2×number of detected spikes+M) of the single regression model described above is generated from a graph in which multiple combinations of a spike number true value (real number) obtained by manual counting in a wheat cultivation field and the number of detected spikes (spike number count value) obtained by detecting and counting wheat spikes from image data of the same wheat cultivation field are plotted, for example, as illustrated in FIG. 5. FIG. 5 illustrates an example where a correction expression of a single regression model “true value y=0.90×number of detected spikes (spike number count value)+110.65” represented by a dashed line segment is generated.

As another example, since a ridge width of ridges where seeding of wheat is performed generally correlates with a degree of denseness of wheat, a ridge width of ridges where seeding is performed may be used as basic information of correction instead of the above-described number of detected spikes (spike number count value). The “ridge” means each of a plurality of rows of regions formed by piling up soil in an elongated linear shape at intervals to make grain in a cultivation field, and the “ridge width” means a width (a dimension in a direction perpendicular to a longitudinal direction) of an elongated linear region.

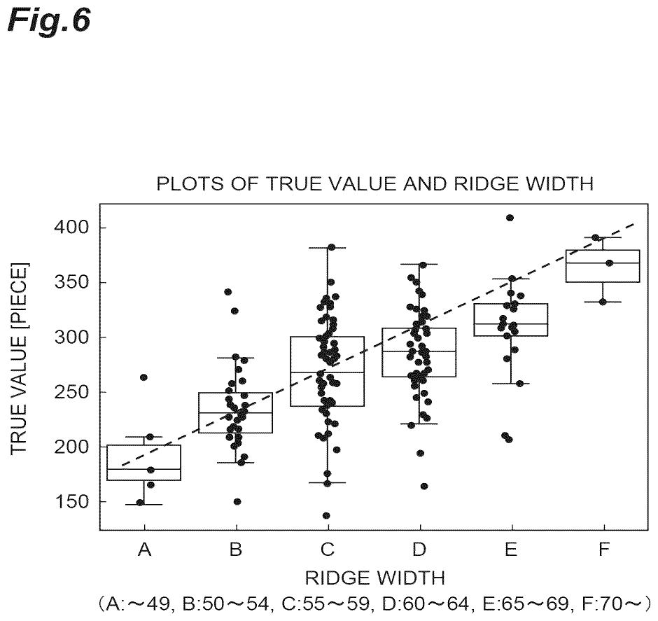

In a case where the ridge width is used, a correction expression of a single regression model (true value=A1×ridge width+B) represented by a dashed line segment may be generated from a graph in which multiple combinations of a wheat spike number true value (real number) obtained by manual counting in a wheat cultivation field and a ridge width (unit:cm) of the same wheat cultivation field are plotted, for example, as illustrated in FIG. 6. In this case, the correction unit 14B may correct the spike number count value using any method, for example, an expression (weighted function or the like) obtained empirically or by an experiment in advance such that the spike number count value obtained by counting in the counting unit 14A approaches the true value obtained by applying the ridge width to the above-described correction expression.

As another example, the correction unit 14B may generate a correction expression (true value=A1×ridge width+A2×number of detected spikes+B) of a multiple regression model using both the number of detected spikes (spike number count value) and the ridge width. That is, the correction unit 14B may obtain a predicted true value by applying both the ridge width and the number of detected spikes (spike number count value) to such a correction expression and may correct the spike number count value using any method, for example, an expression (weighted function or the like) obtained empirically or by an experiment in advance such that the spike number count value approaches the true value. As still another example, the correction unit 14B may correct the spike number count value with a degree of growth of wheat (for example, an average value of thickness of stalk or an average value of length of stalk) recognized from image data of the wheat cultivation field as further basic information.

Returning to FIG. 2, next, the spike number prediction unit 14C predicts, based on a relative size relationship between a predetermined target range (for example, the entire wheat cultivation field 30) and the frame F, and a corrected spike number value after correction in the correction unit 14B, the number of wheat spikes in the target range (Step S9), and outputs a predicted spike number value of the target range (Step S10). For example, in a case where the target range (for example, the entire wheat cultivation field 30) has an area N times the frame F as the relative size relationship, the predicted spike number value is obtained by multiplying the corrected spike number value after correction by N and is output. The “output” herein includes outputs in various forms such as display output on a display, print output to a printer, and data transmission to an external device.

According to the embodiment described above, image data of the region outside the frame F is excluded from image data of the first divided images, and further, the image after exclusion is subjected to grid division in the division size according to the size of the target object (wheat spike). Thus, the “second divided images” in which the proportion of the pixels occupied by the target object is appropriately increased while avoiding a situation in which the features of the target object become unclear or disappear are obtained. The target objects (wheat spikes) are detected from such second divided images, and in this case, it is possible to improve the detection accuracy of the target objects (wheat spikes) in the second divided images. Then, the number of wheat spikes detected with satisfactory accuracy is counted, and the number of wheat spikes in the target range is predicted from the relative size relationship between the target range and the frame F, and the wheat spike number count value. Thus, it is possible to predict the number of wheat spikes in the target range with satisfactory accuracy.

With the correction processing by the correction unit 14B, it is possible to predict the number of spikes with more satisfactory accuracy by compensating for information unreadable or illegible from an image such as wheat spikes hidden behind leaves and densely distributed spikes. In a case where the ridge width is used as the basis of correction, there is an advantage that the spike number count value can be corrected accurately and simply based on ridge width information to be easily acquired without influence of change in color of wheat. In an example where correction is performed further based on the degree of growth of wheat (for example, an average value of thickness of stalk or an average value of length of stalk), in particular, in a case where image data is acquired by imaging the wheat cultivation field obliquely, there is a correlation that as the degree of growth of wheat becomes higher, wheat spikes are more highly likely to be hidden behind leaves and the like. Thus, correction is performed further in consideration of the degree of growth of wheat, so that there is an advantage that an effect of approaching the true value is increased.

### Modification Example of “Two-Dimensional Unit Region” Set in Wheat Cultivation Field

In the above-described embodiment, although an example where the real rectangular frame F provided in the wheat cultivation field is used as an example of the “two-dimensional unit region” set in the wheat cultivation field has been described, other than this example, the two-dimensional coordinate system set in the image of the wheat cultivation field in image processing is used, and (1) a rectangular region in which directions of respective sides are predetermined and specified from coordinates of both ends of a diagonal line, set in the wheat cultivation field may be used or (2) a region specified by arranging a plurality of rectangles having known longitudinal and lateral lengths along a predetermined biaxial direction with one-point coordinates set in a wheat cultivation field as a reference may be used. An example of (1) described above is a pseudo rectangular region (white region) specified from coordinates of both ends (coordinates of two points on upper right side and a lower left side with star marks) of a diagonal line in a rectangle in which directions of respective sides are predetermined, as illustrated in FIG. 4(a). An example of (2) described above is a pseudo rectangular region specified by arranging ten objects X in each of a longitudinal direction and a lateral direction with coordinates of one point on an upper left side with a star mark as a reference in a case where an object X of longitudinal 8 cm×lateral 10 cm is reflected, as illustrated in FIG. 4(b).

### Modification Example of Grid Division in Step S6 of FIG. 2

In Step S6 of FIG. 2, in a case where the image after outside region exclusion is subjected to grid division to obtain a plurality of second divided images, the target object detection unit 13 may perform grid division with a line having a surplus (margin) outside the divided region from the grid division line, not the grid division line, as a reference, and may obtain a divided image in which a region is expanded outward by the surplus, as an individual second divided image. The above-described surplus is determined according to a size of a target object (wheat spike) to be detected, and an appropriate surplus region that is not too wide and not too narrow is added. In this case, the target object detection unit 13 detects the target objects (wheat spike) in the individual second divided image expanded outward by the surplus and can detect the target objects (wheat spikes) positioned on the grid division line without exception.

Note that, in the above-described case, since the surplus regions overlap in adjacent second divided regions, double counting may occur in the counting of the number of wheat spikes. Accordingly, in a case where grid division is performed with the line having the surplus as a reference as described above, the prediction unit 14 corrects the spike number count values of adjacent second divided regions to reduce the number of double-counted spikes as follows. For example, in wheat spikes detected and counted in adjacent second divided regions, detected objects (wheat spikes) (that is, the same wheat spikes that are double counted) whose two-dimensional coordinates in the two-dimensional coordinate system set in the image of the wheat cultivation field in image processing are identical are detected, and the spike number count value may be corrected such that the number of detected objects (a surplus by double counting) is subtracted from the spike number count value. With the above, it is possible to detect the target objects (wheat spikes) positioned on the grid division line while avoiding a harmful influence of double counting, and to contribute to the improvement of the accuracy of spike number prediction.

In the embodiment described above, although an example where “the number of wheat spikes” is predicted as “the number of spikes of the grain” has been described, the technique of the present disclosure can be applied to a case where the number of spikes of grain such as rice, millet, or barnyard millet other than wheat is predicted, and similar effects are obtained.

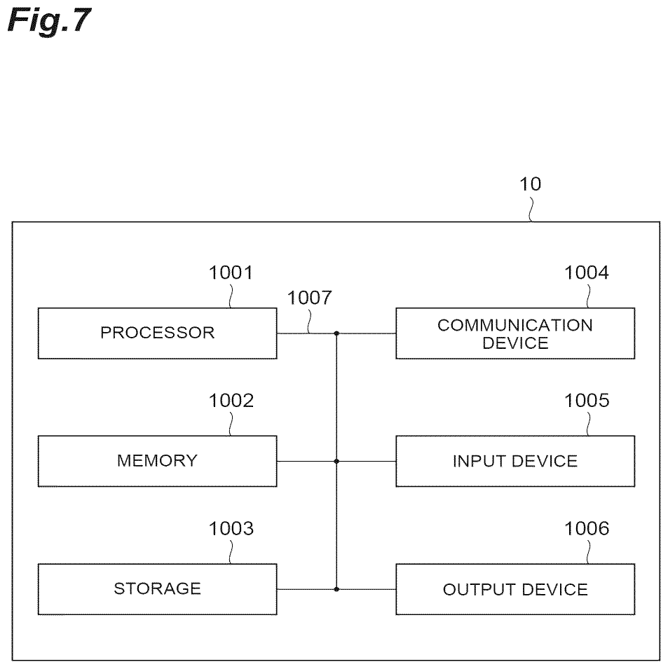

### Description of Terms, Description of Hardware Configuration (FIG. 7), and the Like

The block diagram used to describe the above-described embodiment and the modification examples illustrates blocks in units of functions. These functional blocks (constituent units) are implemented in any combination of at least one of hardware and software. Also, the implementation method of each functional block is not particularly limited. That is, each functional block may be implemented using one device combined physically or logically or may be implemented by directly or indirectly connecting two or more devices separated physically or logically (for example, in a wired or wireless manner) and using the plurality of devices. The functional blocks may be implemented by combining software with one device or the plurality of devices.

The functions include determining, deciding, judging, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like, but are not limited thereto. For example, a functional block (configuration unit) that causes transmitting is referred to as a transmitting unit or a transmitter. In any case, as described above, the implementation method is not particularly limited.

For example, the spike number prediction device in an embodiment of the present disclosure may function as a computer that executes processing in the present embodiment. FIG. 7 is a diagram illustrating a hardware configuration example of the spike number prediction device 10 according to the embodiment of the present disclosure. The above-described spike number prediction device 10 may be physically configured as a computer device including a processor 1001, a memory 1002, a storage 1003, a communication device 1004, an input device 1005, an output device 1006, a bus 1007, and the like.

In the following description, the term “device” can be replaced with a circuit, a device, a unit, or the like. The hardware configuration of the spike number prediction device 10 may be configured to include one or a plurality of devices among the devices illustrated in the drawing or may be configured without including part of the devices.

Each function in the spike number prediction device 10 is implemented by having the processor 1001 perform an arithmetic operation by reading prescribed software (program) on hardware such as the processor 1001 and the memory 1002, and control communication by the communication device 1004 or at least one of reading and writing of data in the memory 1002 and the storage 1003.

The processor 1001 operates, for example, an operating system to control the entire computer. The processor 1001 may be configured with a central processing unit (CPU) including an interface with peripheral devices, a control device, an arithmetic device, a register, and the like.

The processor 1001 reads a program (program code), a software module, data, and the like from at least one of the storage 1003 and the communication device 1004 to the memory 1002 and executes various kinds of processing according to the program, the software module, data, and the like. As the program, a program that causes the computer to execute at least a part of the operations described in the above-described embodiment is used. Although the description has been made that various kinds of processing described above are executed by one processor 1001, various kinds of processing may be executed simultaneously or sequentially by two or more processors 1001. The processor 1001 may be implemented by one or more chips. The program may be transmitted from the network via a telecommunication line.

The memory 1002 is a computer-readable recording medium, and may be configured with at least one of, for example, a read only memory (ROM), an erasable programmable ROM (EPROM), an electrically erasable programmable ROM (EEPROM), and a random access memory (RAM). The memory 1002 may be referred to as a register, a cache, a main memory (main storage device), or the like. The memory 1002 can store a program (program code), a software module, or the like that is executable to perform a wireless communication method according to an embodiment of the present invention.

The storage 1003 is a computer-readable recording medium, and may be configured with at least one of, for example, an optical disc such as a compact disc ROM (CD-ROM), a hard disk drive, a flexible disk, a magneto-optical disk (for example, a compact disk, a digital versatile disk, or a Blu-ray (Registered Trademark) disk), a smart card, a flash memory (for example, a card, a stick, or a key drive), a Floppy (Registered Trademark) disk, and a magnetic strip. The storage 1003 may be referred to as an auxiliary storage device. The above-described storage medium may be, for example, a database including at least one of the memory 1002 and the storage 1003 or other appropriate mediums.

The communication device 1004 is hardware (transmission and reception device) that is provided to perform communication between computers via at least one of a wired network and a wireless network, and is also referred to as, for example, a network device, a network controller, a network card, or a communication module.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs an output to the outside. The input device 1005 and the output device 1006 may be integrated (for example, a touch panel). The devices such as the processor 1001 and the memory 1002 are connected by the bus 1007 that is provided to communicate information. The bus 1007 may be configured using a single bus or may be configured using different buses between devices.

Each aspect/embodiment described in the present disclosure may be used alone, may be used in combination, or may be switched according to implementation. Furthermore, notification of predetermined information (for example, notification of “being X”) is not limited to explicit notification, but may be performed by implicit notification (for example, not performing notification of the predetermined information).

While the present disclosure has been described above in detail, it will be apparent to those skilled in the art that the present disclosure is not limited to the embodiments described in the present disclosure. The present disclosure may be implemented as modified and changed aspects without departing from the spirit and scope of the present disclosure defined by the description in the claims. Therefore, the description in the present disclosure is for illustration and does not have any restrictive meaning with respect to the present disclosure.

A process procedure, a sequence, a flowchart, and the like in each aspect/embodiment described in the present disclosure may be in a different order unless inconsistency arises. For example, for the method described in the present disclosure, elements of various steps are presented using an exemplary order, and the elements are not limited to the presented specific order.

Input or output information or the like may be stored in a specific place (for example, a memory) or may be managed using a management table. Information or the like to be input or output can be overwritten, updated, or additionally written. Output information or the like may be deleted. Input information or the like may be transmitted to another device.

The expression “based on” used in the present disclosure does not mean “based on only” unless otherwise described. In other words, the expression “based on” means both “based on only” and “based on at least”.

In the present disclosure, in a case where the terms “include”, “including”, and modifications thereof are used, these terms are intended to be comprehensive similarly to the term “comprising”. In addition, the term “or” used in the present disclosure is intended not to be an exclusive OR.

In the present disclosure, for example, in a case where an article such as “a”, “an”, or “the” in English is added through translation, the present disclosure may include a case where a noun following the article is of a plural form.

In the present disclosure, the term “A and B are different” may mean that “A and B are different from each other”. This term may mean that “each of A and B is different from C”. Terms “separate” and “coupled” may also be interpreted in a similar manner to “different”.

### REFERENCE SIGNS LIST

10: Spike number prediction device, 11: Angle detection unit, 12: Exclusion unit, 13: Target object detection unit, 14: Prediction unit, 14A: Counting unit, 14B: Correction unit, 14C: Spike number prediction unit, 20: Camera, 30: Wheat cultivation field, 1001: Processor, 1002: Memory, 1003: Storage, 1004: Communication device, 1005: Input device, 1006: Output device, 1007: Bus.

1. A spike number prediction device that predicts the number of spikes of grain, the spike number prediction device comprising:
a spike number counting unit configured to count, from image data of the grain obtained by imaging a two-dimensional unit region set in a cultivation field of the grain, the number of spikes of the grain of the two-dimensional unit region based on an image recognition technique;
a correction unit configured to correct a spike number count value obtained by counting in the spike number counting unit based on correlation information between a spike number count value obtained in advance by statistical processing and a spike number true value; and
a spike number prediction unit configured to predict, based on a relative size relationship between a predetermined target range in the cultivation field of the grain and the two-dimensional unit region, and the corrected spike number value after correction by the correction unit, the number of spikes of the grain in the target range.

2. The spike number prediction device according to claim 1, wherein the correction unit is configured to perform correction based on a ridge width of ridges where seeding of the grain is performed, having a predetermined correlation with a degree of denseness of the grain.

3. The spike number prediction device according to claim 1, wherein the correction unit is configured to perform correction further based on a degree of growth of the grain.

4. The spike number prediction device according to claim 2, wherein the correction unit is configured to perform correction further based on a degree of growth of the grain.
